(19) United States
(12) Patent Application Publication
(10) Pub. No.: US 2012/0182633 A1
(43) Pub. Date: Jul. 19, 2012

(54) LENS DRIVE MECHANISM, LENS BARREL, AND IMAGING APPARATUS

(75) Inventors: Keishi KOBAYASHI, Kanagawa (JP); Toshiaki Edamitsu, Tokyo (JP); Naoko Matsubara, Chiba (JP)

(73) Assignee: Sony Corporation, Tokyo (JP)

(21) Appl. No.: 13/338,594

(22) Filed: Dec. 28, 2011

(30) Foreign Application Priority Data
Jan. 13, 2011 (JP) 2011-005268

(51) Int. Cl. G02B 7/04

(52) U.S. Cl. 359/823

(57) ABSTRACT

A lens drive mechanism includes: a lens holding frame that holds a lens and has a guided portion and a nut support; a nut member so supported by the nut support that the nut member pivotally moves around an optical axis of the lens; a lead screw that engages with the nut member and rotates around an axis of the lead screw to move the lens holding frame; and a guide unit that is inserted into the guided portion of the lens holding frame and guides the lens holding frame in the optical axis direction when the lead screw rotates and moves the lens holding frame. The guide unit, the lead screw, and the lens holding frame are accommodated in and attached to a lens barrel housing having an insertion opening, and the lens holding frame is inserted through the insertion opening and accommodated in the lens barrel housing.

### FIELD

The present disclosure relates to a technical field of a lens drive mechanism, a lens barrel, and an imaging apparatus, and particularly to a technical field of improving workability of assembling a lens holding frame and a nut member in a lens barrel housing by allowing a nut support in the lens holding frame to have a holding portion that holds the nut member in a holding position.

### BACKGROUND

A variety of imaging apparatuses, such as a video camcorder and a still camera, accommodate a lens barrel in which an optical system formed of lenses and other components is disposed and capture an image a subject through the optical system in the lens barrel.

Some imaging apparatuses of this type include a lens drive mechanism so configured that an optical system in a lens barrel is formed of a plurality of lens groups, some of which are moved along the optical axis of the optical system for zooming and focusing (see JP-A-2009-139516, for example).

In the lens drive mechanism described in JP-A-2009-139516, a nut support in a lens holding frame that holds lenses supports a nut member that engages with a lead screw in such a way that the nut member pivotally moves around the optical axis of the lenses.

The lens barrel includes a lens barrel housing having necessary portions disposed therein and also having, for example, an insertion opening that is a front opening and an insertion hole that is an upper opening. The nut member, along with the lens holding frame, is inserted through the insertion opening into the lens barrel housing, and the nut member inserted into the lens barrel housing is positioned in the insertion hole. After the nut member is positioned in the insertion hole, the lead screw is inserted downward through the insertion hole into the lens barrel housing and allowed to engage with the nut member.

### SUMMARY

However, since the nut member engages with the lead screw when the lead screw is inserted downward into the lens barrel housing, the nut member supported by the nut support protrudes upward from the lens holding frame.

In this case, when the lens holding frame and the nut member are inserted through the insertion opening of the lens barrel housing, the nut member tends to come into contact with the edge of the insertion opening, which may compromise the workability of assembling the lens holding frame and the nut member in the lens barrel housing.

To improve the workability of assembling the lens holding frame and the nut member in the lens barrel housing, it is conceivable to enlarge the insertion opening, which however causes the lens barrel housing and hence the imaging apparatus to increase in size.

It is therefore desirable to provide a lens drive mechanism, a lens barrel, and an imaging apparatus that overcome the problems described above and improve the workability of assembling the lens holding frame and the nut member in the lens barrel housing without any increase in size of the imaging apparatus.

An embodiment of the present disclosure is directed to a lens drive mechanism including a lens holding frame that holds a lens and has a guided portion and a nut support, a nut member so supported by the nut support that the nut member pivotally moves around an optical axis of the lens, a lead screw that engages with the nut member and rotates around an axis of the lead screw to move the lens holding frame, and a guide unit that is inserted into the guided portion of the lens holding frame and guides the lens holding frame in the optical axis direction when the lead screw rotates and moves the lens holding frame. The guide unit, the lead screw, and the lens holding frame are accommodated in and attached to a lens barrel housing having an insertion opening. The lens holding frame, which supports the nut member, is inserted through the insertion opening and accommodated in the lens barrel housing. The nut member pivotally moves between an engaging position where the nut member engages with the lead screw and a holding position where the nut member is held when the lens holding frame is inserted into the lens barrel housing. A holding portion that holds the nut member in the holding position is provided at the nut support of the lens holding frame.

In the thus configured lens drive mechanism, the lens holding frame and the nut member can be inserted through the insertion opening into the lens barrel housing with the nut member held in the holding position.

It is preferred that the lens drive mechanism described above further includes an urging spring that urges the lens holding frame in a direction in which the guided portion is pressed against the guide unit in a direction perpendicular to the optical axis and urges the nut member in a direction in which the nut member is pressed against the lead screw in the direction perpendicular to the optical axis, and an urging force produced by the urging spring desirably presses part of the nut member against the holding portion so that the nut member is held in the holding position.

Since the urging spring urges and presses part of the nut member against the holding portion to hold the nut member in the holding position, it is not necessary to provide a dedicated spring member for holding the nut member in the holding position.

In the lens drive mechanism described above, it is preferable that the urging spring urges the nut member in the optical axis direction, and that an urging force produced by the urging spring presses part of the nut member against the holding portion so that the nut member is held in the holding position.

Since the urging spring urges and presses part of the nut member against the holding portion to hold the nut member in the holding position, it is not necessary to provide a dedicated spring member for holding the nut member in the holding position.

It is preferred that the lens drive mechanism described above further includes an urging spring that urges the lens holding frame in a direction in which the guided portion is pressed against the guide unit in a direction perpendicular to the optical axis, urges the nut member in a direction in which the nut member is pressed against the lead screw in the direction perpendicular to the optical axis, and urges the nut member in the optical axis direction, and urging forces produced by the urging spring in the direction perpendicular to the optical axis and in the optical axis direction desirably press part of the nut member against the holding portion so that the nut member is held in the holding position.

Since the urging spring urges and presses part of the nut member against the holding portion to hold the nut member in the holding position, it is not necessary to provide a dedicated spring member for holding the nut member in the holding position.

It is preferred that the lens drive mechanism described above further includes a releaser in the lens barrel housing, the releaser releasing the nut member held in the holding position.

Providing a releaser in the lens barrel housing that releases the nut member held in the holding position allows the nut member to pivot toward the engaging position when the lens holding frame and the nut member are accommodated in the lens barrel housing.

In the lens drive mechanism described above, it is preferred that the lead screw is attached to the lens barrel housing by allowing the lead screw to engage with the nut member held in the holding position and moving the lead screw in a predetermined direction, and that when the lead screw is moved in the predetermined direction, the nut member pivots relative to the nut support and disengages from the holding position.

Configuring the nut member to pivot relative to the nut support and disengage from the holding position when the lead screw is moved in a predetermined direction allows the nut member held in the holding position to be released when the lead screw is attached to the lens barrel housing.

In the lens drive mechanism described above, it is preferred that a shaft is provided on one of the nut member and the nut support and a shaft-receiving portion into which the shaft is inserted is provided on the other one of the nut member and the nut support. The nut member is desirably so supported by the nut support that the nut member pivotally moves around the optical axis of the lens. A shaft-side wedged portion and a receiving-side wedged portion are desirably so formed on the shaft and the shaft-receiving portion that the wedged portions protrude in a direction perpendicular to axes thereof, have tapered shapes, and come into contact with each other.

Forming the shaft-side wedged portion and the receiving-side wedged portion, which protrude in the direction perpendicular to the axes of the shaft and the shaft-receiving portion, have tapered shapes, and come into contact with each other, on the shaft and the shaft-receiving portion allows the distances from the pivotal point of the shaft to the contact points where the shaft and the shaft-receiving portion come into contact with each other to be reduced.

In the lens drive mechanism described above, it is preferred that the urging spring urges the nut member in the optical axis direction.

When the urging spring urges the nut member in the optical axis direction, the nut member is pressed against the nut support in the optical axis direction.

In the lens drive mechanism described above, it is preferred that the urging spring is a compression coil spring.

Using a compression coil spring as the urging spring allows the compression coil spring to urge the relevant components in desired directions.

In the lens drive mechanism described above, it is preferred that the urging spring is formed of a coil portion, a first engaging portion protruding from one axial end of the coil portion, and a second engaging portion protruding from the other axial end of the coil portion. It is preferred that the first engaging portion engages with the nut member and the second engaging portion engages with the lens holding frame. It is preferred that the nut member and the lens holding frame are urged in opposite directions around an axis of the coil portion.

Configuring the nut member and the lens holding frame to be urged in opposite directions around the axis of the coil portion allows the nut member and the lens holding frame to be urged in a direction in which the nut member and the lens holding frame are pressed against the lead screw and the guide unit, respectively.

In the lens drive mechanism described above, it is preferred that a guided-side wedged portion is formed in the guided portion, the guided-side wedged portion protruding in a direction perpendicular to an axis of the guided portion and having a tapered shape.

Forming the guided-side wedged portion protruding in the direction perpendicular to the axis of the guided portion and having a tapered shape reduces the sliding resistance between the lens holding frame and the guide unit.

In the lens drive mechanism described above, it is preferred that a fluorine coat is formed on the guide unit.

Forming a fluorine coat on the guide unit reduces the sliding resistance between the lens holding frame and the guide unit produced when the lens holding frame is guided along the guide unit.

In the lens drive mechanism described above, it is preferred that a fluorine coat is formed on a portion of the guided portion of the lens holding frame that comes into contact with the guide unit.

Forming a fluorine coat on a portion of the guided portion of the lens holding frame that comes into contact with the guide unit reduces the sliding resistance between the lens holding frame and the guide unit produced when the lens holding frame is guided along the guide unit.

Another embodiment of the present disclosure is directed to a lens barrel including a lens barrel housing that accommodates at least one lens and has an insertion opening, a lens holding frame that holds the lens and has a guided portion and a nut support, a nut member so supported by the nut support that the nut member pivotally moves around an optical axis of the lens, a lead screw that engages with the nut member and rotates around an axis of the lead screw to move the lens holding frame, and a guide unit that is inserted into the guided portion of the lens holding frame and guides the lens holding frame in the optical axis direction when the lead screw rotates and moves the lens holding frame. The guide unit, the lead screw, and the lens holding frame are accommodated in and attached to the lens barrel housing. The lens holding frame, which supports the nut member, is inserted through the insertion opening and accommodated in the lens barrel housing. The nut member pivotally moves between an engaging position where the nut member engages with the lead screw and a holding position where the nut member is held when the lens holding frame is inserted into the lens barrel housing. A holding portion that holds the nut member in the holding position is provided at the nut support of the lens holding frame.

In the thus configured lens barrel, the lens holding frame and the nut member can be inserted through the insertion opening into the lens barrel housing with the nut member held in the holding position.

Still another embodiment of the present disclosure is directed to an imaging apparatus including a lens barrel that accommodates an optical system and an imaging device that converts an optical image acquired through the optical system into an electric signal. The lens barrel includes a lens barrel housing that accommodates at least one lens and has an insertion opening, a lens holding frame that holds the lens and has a guided portion and a nut support, a nut member so supported by the nut support that the nut member pivotally moves around an optical axis of the lens, a lead screw that engages with the nut member and rotates around an axis of the lead screw to move the lens holding frame, and a guide unit that is inserted into the guided portion of the lens holding frame and guides the lens holding frame in the optical axis direction when the lead screw rotates and moves the lens holding frame. The guide unit, the lead screw, and the lens holding frame are accommodated in and attached to the lens barrel housing. The lens holding frame, which supports the nut member, is inserted through the insertion opening and accommodated in the lens barrel housing. The nut member pivotally moves between an engaging position where the nut member engages with the lead screw and a holding position where the nut member is held when the lens holding frame is inserted into the lens barrel housing. A holding portion that holds the nut member in the holding position is provided at the nut support of the lens holding frame.

In the thus configured imaging apparatus, the lens holding frame and the nut member can be inserted through the insertion opening into the lens barrel housing with the nut member held in the holding position.

A lens drive mechanism according to one embodiment of the present disclosure includes a lens holding frame that holds a lens and has a guided portion and a nut support, a nut member so supported by the nut support that the nut member pivotally moves around an optical axis of the lens, a lead screw that engages with the nut member and rotates around an axis of the lead screw to move the lens holding frame, and a guide unit that is inserted into the guided portion of the lens holding frame and guides the lens holding frame in the optical axis direction when the lead screw rotates and moves the lens holding frame. The guide unit, the lead screw, and the lens holding frame are accommodated in and attached to a lens barrel housing having an insertion opening. The lens holding frame, which supports the nut member, is inserted through the insertion opening and accommodated in the lens barrel housing. The nut member pivotally moves between an engaging position where the nut member engages with the lead screw and a holding position where the nut member is held when the lens holding frame is inserted into the lens barrel housing. A holding portion that holds the nut member in the holding position is provided at the nut support of the lens holding frame.

The lens holding frame and the nut member can therefore be assembled in the lens barrel housing with improved workability without any increase in size of the lens barrel housing.

In a preferred embodiment of the present disclosure, the lens drive mechanism further includes an urging spring that urges the lens holding frame in a direction in which the guided portion is pressed against the guide unit in a direction perpendicular to the optical axis and urges the nut member in a direction in which the nut member is pressed against the lead screw in the direction perpendicular to the optical axis, and an urging force produced by the urging spring presses part of the nut member against the holding portion so that the nut member is held in the holding position.

It is therefore not necessary to provide a dedicated spring member for holding the nut member in the holding position, whereby the number of parts and hence the manufacturing cost can be reduced.

In a preferred embodiment of the present disclosure, the urging spring urges the nut member in the optical axis direction, and an urging force produced by the urging spring presses part of the nut member against the holding portion so that the nut member is held in the holding position.

It is therefore not necessary to provide a dedicated spring member for holding the nut member in the holding position, whereby the number of parts and hence the manufacturing cost can be reduced.

In a preferred embodiment of the present disclosure, the lens drive mechanism further includes an urging spring that urges the lens holding frame in a direction in which the guided portion is pressed against the guide unit in a direction perpendicular to the optical axis, urges the nut member in a direction in which the nut member is pressed against the lead screw in the direction perpendicular to the optical axis, and urges the nut member in the optical axis direction, and urging forces produced by the urging spring in the direction perpendicular to the optical axis and in the optical axis direction presses part of the nut member against the holding portion so that the nut member is held in the holding position.

It is therefore not necessary to provide a dedicated spring member for holding the nut member in the holding position, whereby the number of parts and hence the manufacturing cost can be reduced.

In a preferred embodiment of the present disclosure, the lens drive mechanism further includes a releaser in the lens barrel housing, the releaser releasing the nut member held in the holding position.

The nut member therefore pivots toward the engaging position when the lens holding frame and the nut member are accommodated in the lens barrel housing, whereby the lead screw and the nut member can be quickly and smoothly assembled.

In a preferred embodiment of the present disclosure, the lead screw is attached to the lens barrel housing by allowing the lead screw to engage with the nut member held in the holding position and moving the lead screw in a predetermined direction, and when the lead screw is moved in the predetermined direction, the nut member pivots relative to the nut support and disengage from the holding position.

It is therefore unnecessary to provide a dedicated part for releasing the nut member held in the holding position, and the nut member held in the holding position can be readily and reliably released when the lead screw is assembled in the lens barrel housing.

In a preferred embodiment of the present disclosure, a shaft is provided on one of the nut member and the nut support and a shaft-receiving portion into which the shaft is inserted is provided on the other one of the nut member and the nut support. In this case, the nut member is so supported by the nut support that the nut member pivotally moves around the optical axis of the lens. Also, a shaft-side wedged portion and a receiving-side wedged portion are so formed on the shaft and the shaft-receiving portion that the wedged portions protrude in a direction perpendicular to axes thereof, have tapered shapes, and come into contact with each other.

Any waviness of the lead screw and hence a decentered rotation axis thereof produced when the lead screw rotates will therefore not be transferred, for example, in the form of large oscillation from the nut member to the lens via the lens holding frame. Image jitter, image hopping, and other harmful phenomena will therefore not occur.

In a preferred embodiment of the present disclosure, the urging spring urges the nut member in the optical axis direction.

There will therefore be no play between the nut member and the lens holding frame, and the lens held in the lens holding frame is stably positioned in the optical axis direction, whereby the position of the lens can be detected with improved precision and zooming and focusing can be performed with improved reliability.

In a preferred embodiment of the present disclosure, the urging spring is a compression coil spring.

A simple mechanism using the urging spring therefore allows the relevant components to be urged in desired directions, whereby the number of parts and the manufacturing cost can be reduced.

In a preferred embodiment of the present disclosure, the urging spring is formed of a coil portion, a first engaging portion protruding from one axial end of the coil portion, and a second engaging portion protruding from the other axial end of the coil portion. In this case, the first engaging portion engages with the nut member and the second engaging portion engages with the lens holding frame. Also, the nut member and the lens holding frame are urged in opposite directions around an axis of the coil portion.

The nut member and the lens holding frame can therefore be reliably and readily urged in desired directions, and these components can be reliably and appropriately operated while the number of parts and the manufacturing cost are reduced.

In a preferred embodiment of the present disclosure, a guided-side wedged portion is formed in the guided portion, the guided-side wedged portion protruding in a direction perpendicular to an axis of the guided portion and having a tapered shape.

The sliding resistance between the lens holding frame and the guide unit is therefore small, whereby the lens holding frame can move smoothly along the guide unit in the optical axis direction, and image jitter, image hopping, and other harmful phenomena will not occur.

In a preferred embodiment of the present disclosure, a fluorine coat is formed on the guide unit.

The sliding resistance produced when the lens holding frame is guided along the guide unit therefore decreases, whereby the lens holding frame can smoothly move.

In a preferred embodiment of the present disclosure, a fluorine coat is formed on a portion of the guided portion of the lens holding frame that comes into contact with the guide unit.

The sliding resistance produced when the lens holding frame is guided along the guide unit therefore decreases, whereby the lens holding frame can smoothly move.

A lens barrel according to one embodiment of the present disclosure includes a lens barrel housing that accommodates at least one lens and has an insertion opening, a lens holding frame that holds the lens and has a guided portion and a nut support, a nut member so supported by the nut support that the nut member pivotally moves around an optical axis of the lens, a lead screw that engages with the nut member and rotates around an axis of the lead screw to move the lens holding frame, and a guide unit that is inserted into the guided portion of the lens holding frame and guides the lens holding frame in the optical axis direction when the lead screw rotates and moves the lens holding frame. The guide unit, the lead screw, and the lens holding frame are accommodated in and attached to the lens barrel housing. The lens holding frame, which supports the nut member, is inserted through the insertion opening and accommodated in the lens barrel housing. The nut member pivotally moves between an engaging position where the nut member engages with the lead screw and a holding position where the nut member is held when the lens holding frame is inserted into the lens barrel housing. A holding portion that holds the nut member in the holding position is provided at the nut support of the lens holding frame.

The lens holding frame and the nut member can therefore be assembled in the lens barrel housing with improved workability without any increase in size of the lens barrel housing.

An imaging apparatus according to one embodiment of the present disclosure includes a lens barrel that accommodates an optical system and an imaging device that converts an optical image acquired through the optical system into an electric signal. The lens barrel includes a lens barrel housing that accommodates at least one lens and has an insertion opening, a lens holding frame that holds the lens and has a guided portion and a nut support, a nut member so supported by the nut support that the nut member pivotally moves around an optical axis of the lens, a lead screw that engages with the nut member and rotates around an axis of the lead screw to move the lens holding frame, and a guide unit that is inserted into the guided portion of the lens holding frame and guides the lens holding frame in the optical axis direction when the lead screw rotates and moves the lens holding frame. The guide unit, the lead screw, and the lens holding frame are accommodated in and attached to the lens barrel housing. The lens holding frame, which supports the nut member, is inserted through the insertion opening and accommodated in the lens barrel housing. The nut member pivotally moves between an engaging position where the nut member engages with the lead screw and a holding position where the nut member is held when the lens holding frame is inserted into the lens barrel housing. A holding portion that holds the nut member in the holding position is provided at the nut support of the lens holding frame.

The lens holding frame and the nut member can therefore be assembled in the lens barrel housing with improved workability without any increase in size of the lens barrel housing.

### BRIEF DESCRIPTION OF THE DRAWINGS

FIG. 1, along with FIGS. 2 to 25, shows a mode for carrying out the present disclosure and is a schematic cross-sectional view of an imaging apparatus;

FIG. 2 is an exploded perspective view of a lens barrel;

FIG. 3 is another exploded perspective view of the lens barrel viewed in a direction different from the viewing direction in FIG. 2;

FIG. 4 is a perspective view of the lens barrel;

FIG. 5 is an enlarged, exploded perspective view showing a lens holding frame, a nut member, and an urging spring;

FIG. 6 is an enlarged perspective view showing a state in which guide shafts support the lens holding frame and the lens holding frame supports the nut member;

FIG. 7 is another enlarged perspective view showing the state in which the guide shafts support the lens holding frame and the lens holding frame supports the nut member when viewed in a direction different from the viewing direction in FIG. 6;

FIG. 8 is an enlarged perspective view showing a state in which the guide shafts support the lens holding frame, the lens holding frame supports the nut member, and the nut member engages with a lead screw;

FIG. 9 is an enlarged front view showing the state in which the guide shafts support the lens holding frame and the lens holding frame supports the nut member;

FIG. 10 is an enlarged perspective view showing a state in which the nut member is held in an engaging position;

FIG. 11 is an enlarged perspective view showing a state in which the nut member is held in the engaging position and engages with the lead screw;

FIG. 12 is an enlarged perspective view showing a state in which the nut member is held in a holding position;

FIG. 13 is a diagrammatic view for describing advantageous and other effects provided by the urging spring and a wedged portion;

FIG. 14 is an enlarged plan view showing a state in which a held portion engages with a holding portion and the nut member is held in the holding position;

FIG. 15 is a perspective view showing a state in which the lens holding frame and the nut member are inserted in a lens barrel housing;

FIG. 16 is an enlarged plan view showing a state in which the held portion disengages from the holding portion and the nut member is held in the engaging position;

FIG. 17 is a perspective view showing a state in which the lens holding frame and the nut member are accommodated in the lens barrel housing and the nut member pivots from the holding position to the engaging position;

FIG. 18 is a perspective view showing a state in which the lens holding frame and the nut member are accommodated in the lens barrel housing and a lid member is attached to the lens barrel housing;

FIG. 19 is a perspective view showing a state in which the lens holding frame and the nut member are accommodated in the lens barrel housing and a lens holding member is attached to the lid member;

FIG. 20 is a perspective view showing a state in which the lead screw is assembled in an engaging portion of the nut member and a support sheet metal is attached to the lens barrel housing;

FIG. 21 is an enlarged plan view showing a state in which the held portion engages with a stepped surface of the holding portion and the nut member is held in the holding position;

FIG. 22 is an enlarged perspective view showing a state in which a held portion is provided on a base portion of the nut member and a holding portion is formed in a shaft-receiving portion of a nut support;

FIG. 23 is an enlarged front view showing a state in which the lead screw is inserted into the engaging portion of the nut member held in the holding position when the lead screw is assembled in the lens barrel housing;

FIG. 24 is an enlarged front view showing a state in which the lead screw and the support sheet metal are so moved sideways that the nut member held in the holding position is released when the lead screw is assembled in the lens barrel housing; and

FIG. 25 is a block diagram of the imaging apparatus.

### DETAILED DESCRIPTION

A mode for carrying out the present disclosure will be described below with reference to the accompanying drawings.

In the mode described below, an imaging apparatus according to an embodiment of the present disclosure is a video camcorder, a lens barrel according to an embodiment of the present disclosure is a lens barrel provided in the video camcorder, and a lens drive mechanism according to an embodiment of the present disclosure is a lens drive mechanism provided in the video camcorder. It is noted that the present disclosure is not necessarily applied to a video camcorder but is widely applicable to a variety of imaging apparatus, lens barrels, and lens drive mechanisms incorporated in a still camera and other apparatus.

In the following description, the front-rear, up-down, and right-left directions are defined relative to a user who uses a video camcorder to capture an image. That is, the subject side is the front side, and the user side is the rear side.

The front-rear, up-down, and right-left directions used below are described for convenience of description, and the directions defined as described above do not impose any limitation on implementation of the present disclosure.

[Configuration of Imaging Apparatus]

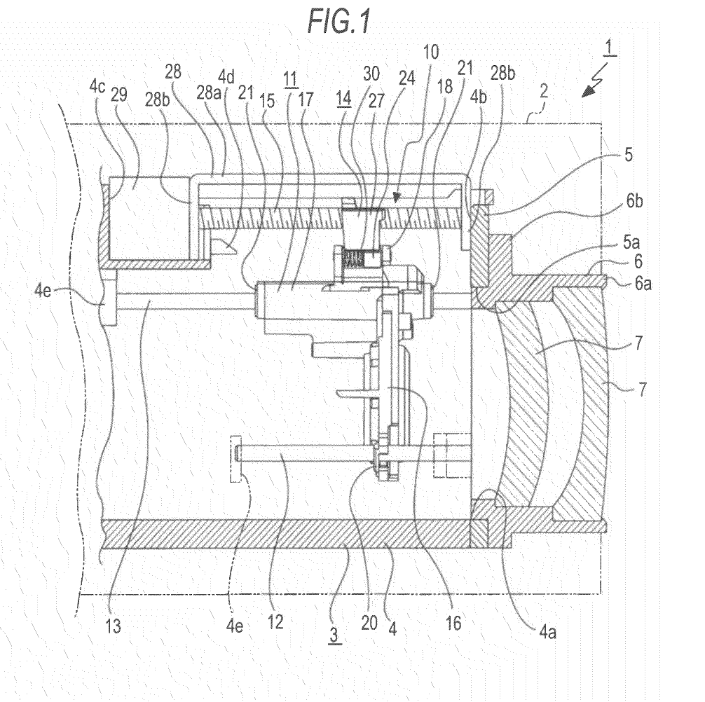

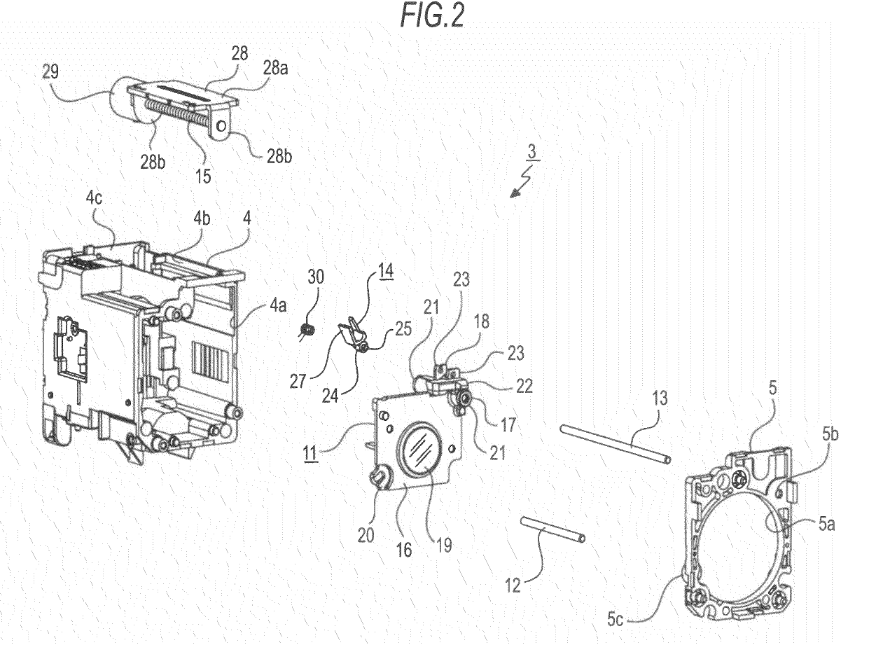

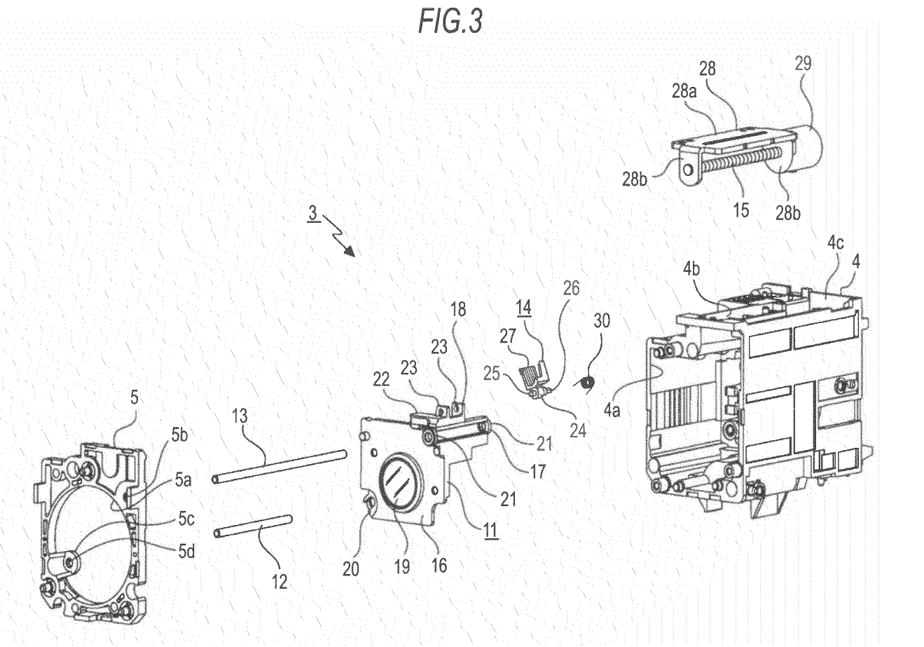

An imaging apparatus 1 is formed of necessary portions disposed inside and outside an exterior enclosure 2 (see FIGS. 1 to 4). A plurality of operation sections (not shown) are disposed on the exterior surface of the exterior enclosure 2. Examples of the operation sections include a power on/off button, a recording button, a zoom switch, and a mode switching knob.

The imaging apparatus 1 also includes a display panel, a viewfinder, and other sections (not shown).

A lens barrel 3 is disposed in the exterior enclosure 2. The lens barrel 3 includes a lens barrel housing 4 and a lid member 5 attached to the front surface of the lens barrel housing 4.

The lens barrel housing 4 has a substantially rectangular, tubular shape extending in the front-rear direction and has a front opening that serves as an insertion opening 4a. An insertion hole 4b is formed through the upper end of the lens barrel housing 4. Specifically, the insertion hole 4b passes through the upper end in the up-down direction, extends in the front-rear direction, and occupies a portion except a rear end portion in the left half of the lens barrel housing 4. A placement recess 4c is further formed in the lens barrel housing 4. The placement recess 4c opens upward and forward and is continuous with the rear side of the insertion hole 4b.

A releaser 4d is provided in the lens barrel housing 4 in a position close to the upper end thereof (see FIG. 1). The releaser 4d protrudes forward from the front surface of a wall that forms the placement recess 4c and has a tapered, inclined surface.

Shaft-receiving protrusions 4e, 4e are provided in the lens barrel housing 4, and each of the shaft-receiving protrusions 4e, 4e has a receiving recess (not shown) that opens forward. One of the shaft-receiving protrusions 4e is disposed in a position close to the upper end in the rear end portion of the lens barrel housing 4, and the other shaft-receiving protrusion 4e is disposed in a position close to the lower end and the rear end of the lens barrel housing 4.

The lid member 5 has a substantially rectangular exterior shape and has a circular light transmitting hole 5a (see FIGS. 1 to 3) . The lid member 5 has a shaft insertion hole 5b passing therethrough in the front-rear direction in a position close to the upper end of the lid member 5. The lid member 5 further has a shaft-receiving protrusion 5c protruding rearward in a position close to the lower end of the lid member 5 and a shaft insertion hole 5d passing through the shaft-receiving protrusion 5c in the front-rear direction.

The lid member 5 is attached to the front surface of the lens barrel housing 4 to block the insertion opening 4a.

A lens holding member 6 is attached to the front surface of the lid member 5 (see FIG. 1). The lens holding member 6 is formed of a lens holding portion 6a having a substantially cylindrical shape and extending in the front-rear direction and a flange 6b overhanging outward from a position close to the rear end of the lens holding portion 6a.

The lens holding portion 6a of the lens holding member 6 holds, for example, two lenses 7, 7, which are arranged in the front-rear direction and form a first lens group.

The flange 6b of the lens holding member 6 is attached to the front surface of the lid member 5, and the portion of the lens holding portion 6a that extends rearward from the flange 6b is inserted into the light transmitting hole 5a of the lid member 5.

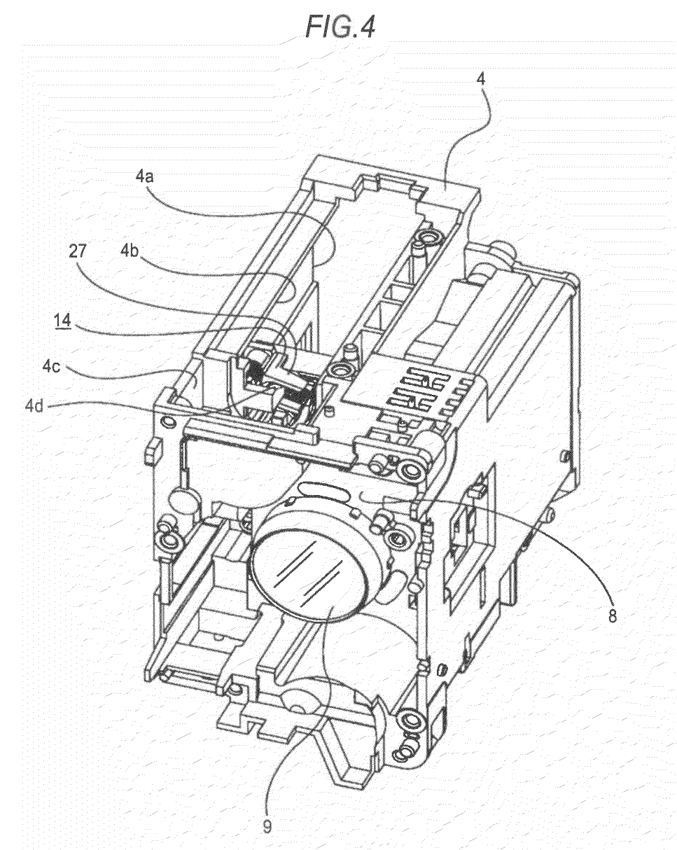

A lens holder 8 is disposed in the lens barrel housing 4 in a position close to the rear end thereof (see FIG. 4). The lend holder 8 holds at least one lens 9 that functions as a third lens group.

A holder (not shown) is attached to the rear end portion of the lens barrel housing 4, and the holder holds a lens that functions as a fifth lens group and an imaging device with the lens and the imaging device arranged in the front-rear direction.

A lens (not shown) that functions as a fourth lens group is disposed between the lens holder 8 in the lens barrel housing 4 and a holder disposed in a position shifted rearward from the lens holder 8 in such a way that the lens is movable in the optical axis direction (the front-rear direction).

A lens drive mechanism 10 is disposed in the lens barrel housing 4 (see FIGS. 1 to 3). The lens drive mechanism 10 includes a lens holding frame 11, guide shafts 12 and 13, a nut member 14, and a lead screw 15.

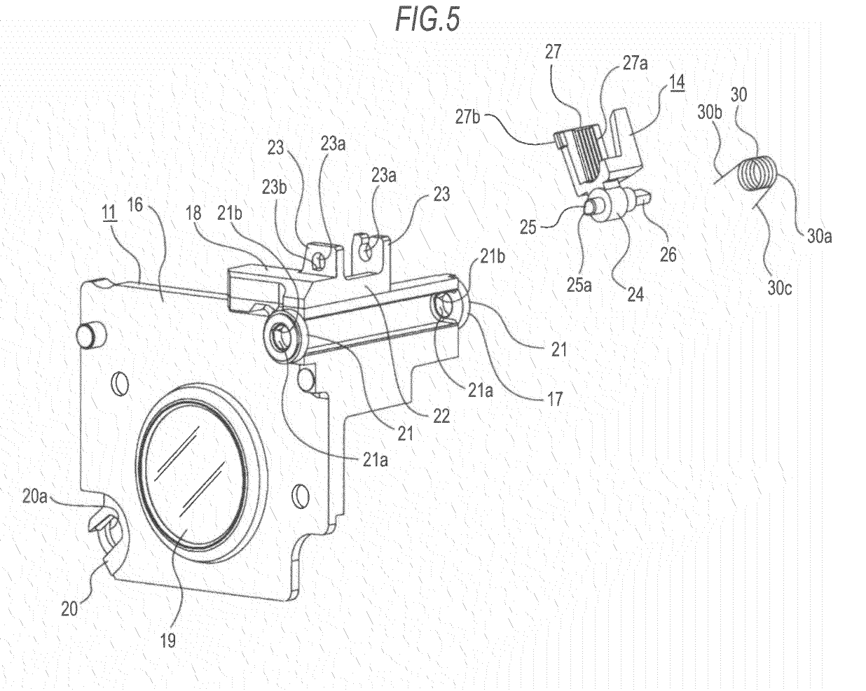

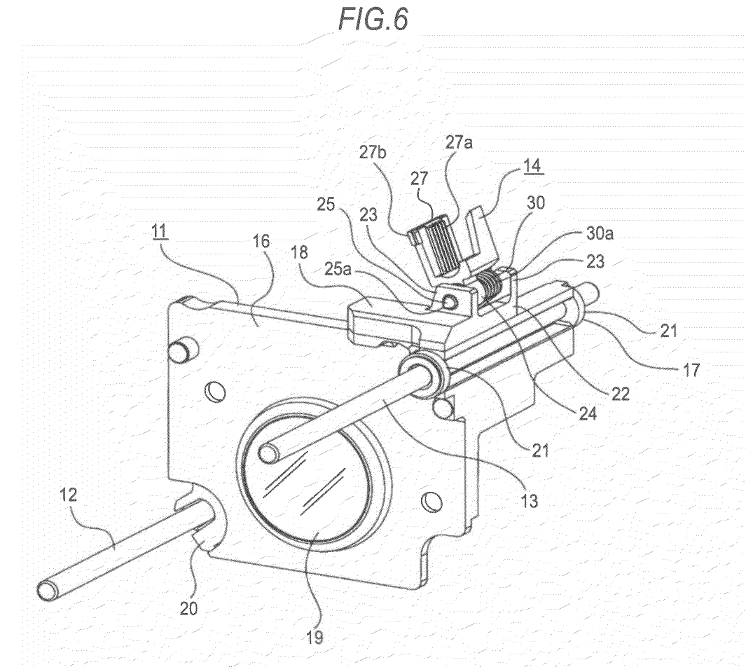

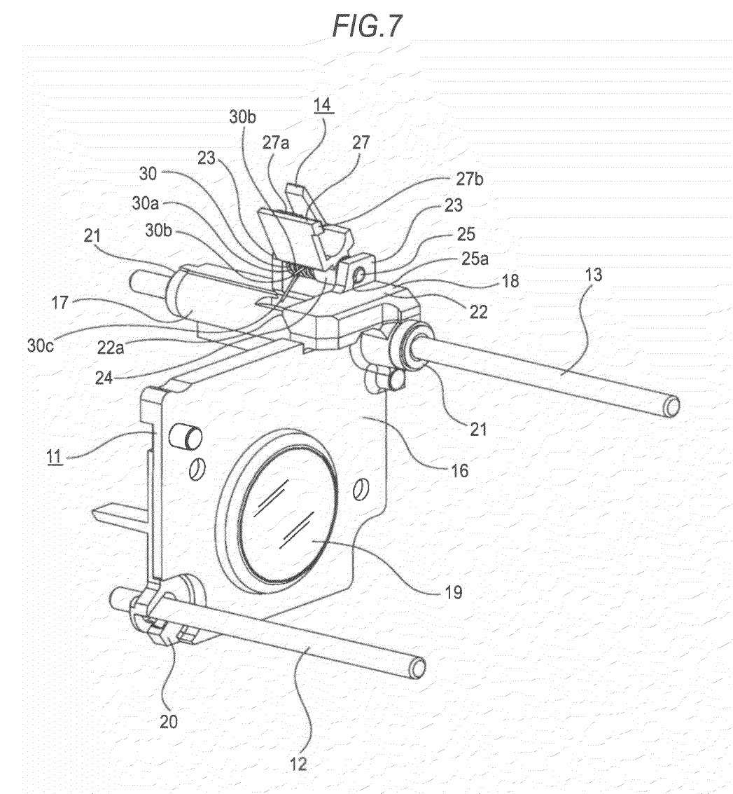

The lens holding frame 11 includes a holding plate 16 facing the front-rear direction, a sleeve 17 protruding in the front-rear direction from an upper left portion of the holding plate 16, and a nut support 18 provided on the upper side of the sleeve 17, as shown in FIGS. 5 to 8.

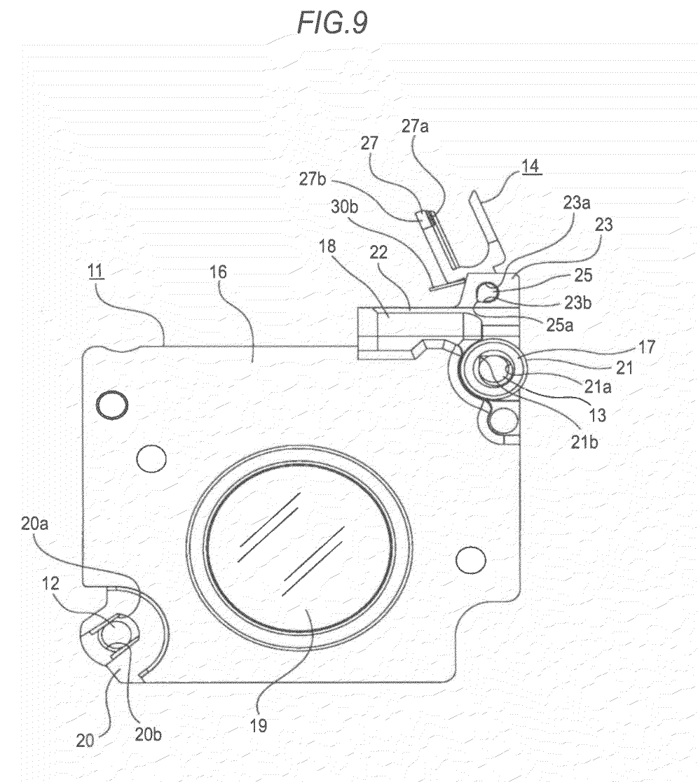

A substantially central portion of the holding plate 16 holds, for example, a plurality of lenses 19, 19, . . . , which function as a second lens group. A lower right portion of the holding plate 16 serves as a guided portion 20. A supported hole 20a is formed through the guided portion 20 in the front-rear direction (see FIG. 9).

The sleeve 17 has a shape elongated in the front-rear direction, and guided portions 21, 21 are provided at front and rear end portions thereof (see FIGS. 5 to 8). A supported hole 21a is formed through each of the guided portions 21, 21 in the front-rear direction, and the supported hole 21a has a guided-side wedged portion 21b protruding in the direction perpendicular to the axial direction of the hole and having a tapered shape (see FIG. 9).

The nut support 18 has a base 22 attached to the upper surface of the sleeve 17 and part of the upper surface of the holding plate 16 and shaft-receiving portions 23, 23 protruding upward from front and rear end portions of the base 22 (see FIGS. 5 to 8).

A holding portion 22a is formed on the rear surface of the portion of the base 22 that is attached to part of the upper surface of the holding plate 16. The holding portion 22a is formed to be an inclined surface extending downward and forward.

A shaft-receiving hole 23a is formed through each of the shaft-receiving portions 23, 23 in the front-rear direction, and the front shaft-receiving hole 23a, for example, has a receiving-side wedged portion 23b protruding in the direction perpendicular to the axial direction of the hole and having a tapered shape (see FIG. 9).

The guide shafts 12 and 13 function as guide units that guide the lens holding frame 11 in the front-rear direction (optical axis direction). The guide shaft 12 is inserted through the supported hole 20a of the guided portion 20 of the lens holding frame 11, and the guide shaft 13 is inserted through the supported holes 21a, 21a of the guided portions 21, 21 of the lens holding frame 11 (see FIGS. 5 to 8). The lens holding frame 11 is supported to be slidable along the guide shafts 12 and 13 inserted through the supported holes 20a, 21a, 21a.

Each of the guide shafts 12 and 13 has a fluorine coat formed on the surface (outer circumferential surface) thereof. The fluorine coat may alternatively be formed on the circumferential surface of each of the supported holes 20a and 21a formed in the guided portions 20 and 21 of the lens holding frame 11 instead of the outer circumferential surface of each of the guide shafts 12 and 13.

Forming the fluorine coat on the outer circumferential surface of each of the guide shafts 12 and 13 or the circumferential surface of each of the supported holes 20a and 21a allows the lens holding frame 11 to be guided along the guide shafts 12 and 13 with reduced sliding resistance between the shafts and the holes, whereby the lens holding frame 11 can smoothly move.

A rear end portion of the guide shaft 12 is supported by the lower shaft-receiving protrusion 4e provided in the lens barrel housing 4 and a front end portion of the guide shaft 12 is supported by the shaft-receiving protrusion 5c provided in a lower portion of the lid member 5. A rear end portion of the guide shaft 13 is supported by the upper shaft-receiving protrusion 4e provided in the lens barrel housing 4 and a front end portion of the guide shaft 13 is inserted through and supported by the shaft insertion hole 5b provided in an upper portion of the lid member 5.

The nut member 14 is formed of a shaft-shaped base portion 24 extending in the front-rear direction, shafts 25 and 26 protruding forward and rearward from the front and rear end surfaces of the base portion 24 respectively, and an engaging portion 27 protruding from the outer circumferential surface of the base portion 24, as shown in FIGS. 5 to 8. The diameter of each of the shafts 25 and 26 is smaller than that of the base portion 24.

The shaft 25 has a shaft-side wedged portion 25a protruding in the direction perpendicular to the axial direction of the shaft and having a tapered shape (see FIG. 9).

The engaging portion 27 has a substantially U-like shape and has a rack 27a formed on the inner surface thereof (see FIGS. 5 to 8). A held portion 27b is so provided that it protrudes forward from the front surface of the engaging portion 27.

The shafts 25 and 26 of the nut member 14 are inserted through the shaft-receiving holes 23a, 23a of the shaft-receiving portions 23, 23, whereby the nut member 14 is pivotally supported by the nut support 18.

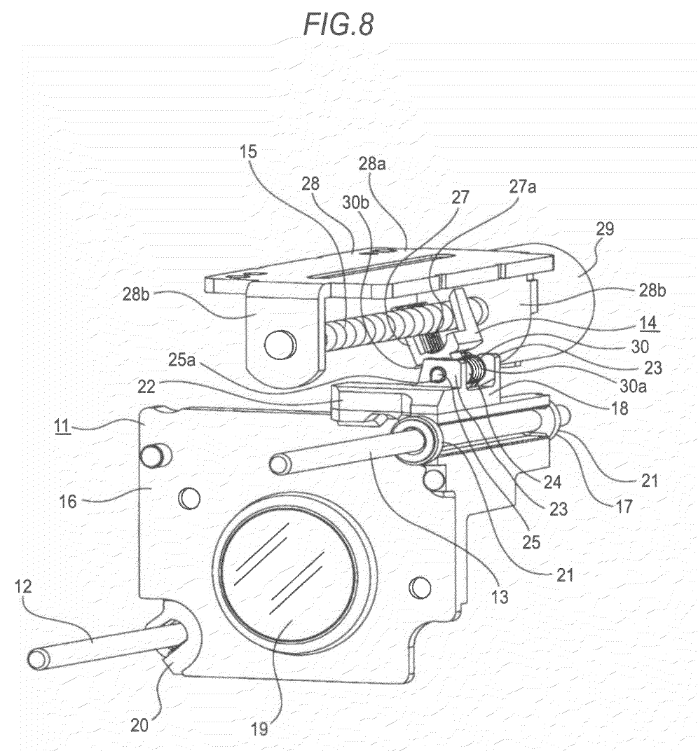

The lead screw 15 is so supported by a support sheet metal 28 that the lead screw 15 can pivot around the axis thereof (see FIG. 8). The support sheet metal 28 is formed of a connecting plate 28a facing in the up-down direction and extending in the front-rear direction and support plates 28b, 28b protruding downward from the front and rear ends of the connecting plate 28a. Front and rear end portions of the lead screw 15 are supported by the support plates 28b, 28b.

A motor 29 is fixed to the rear surface of the rear support plate 28b, and the rear end portion of the lead screw 15 is fixed to a rotating shaft of the motor 29.

The lead screw 15 engages with the rack 27a formed on the engaging portion 27 of the nut member 14. In this configuration, when the motor 29 rotates the lead screw 15, the lead screw 15 moves the nut member 14 in the front-rear direction (optical axis direction), and the lens holding frame 11 and the lenses 19, 19, . . . , which function as the second lens group, are integrally guided along the guide shafts 12 and 13 and moved in the optical axis direction.

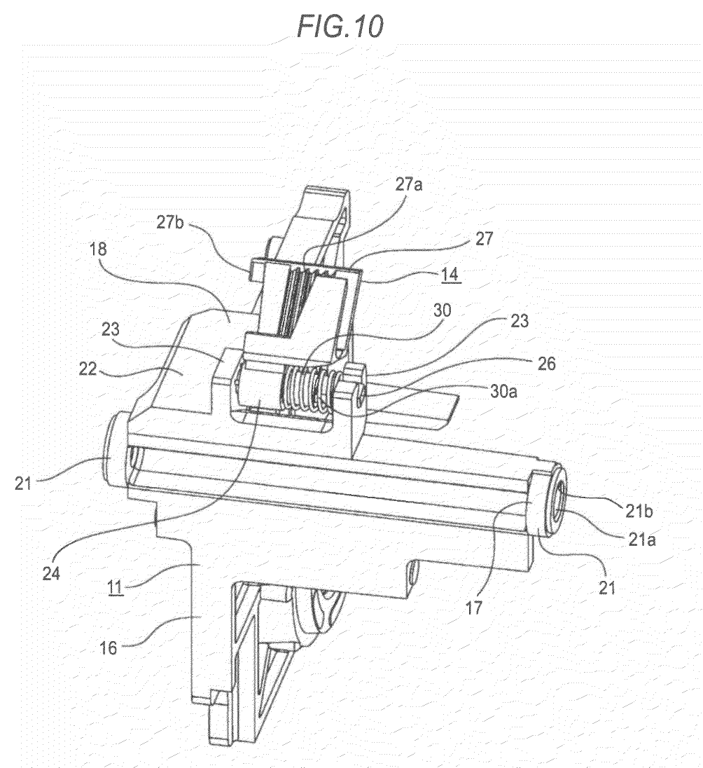

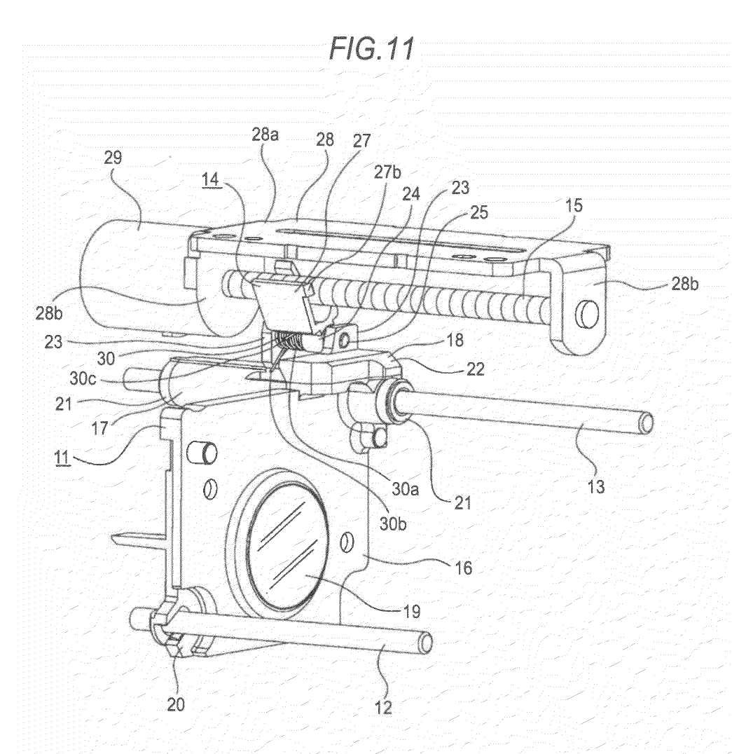

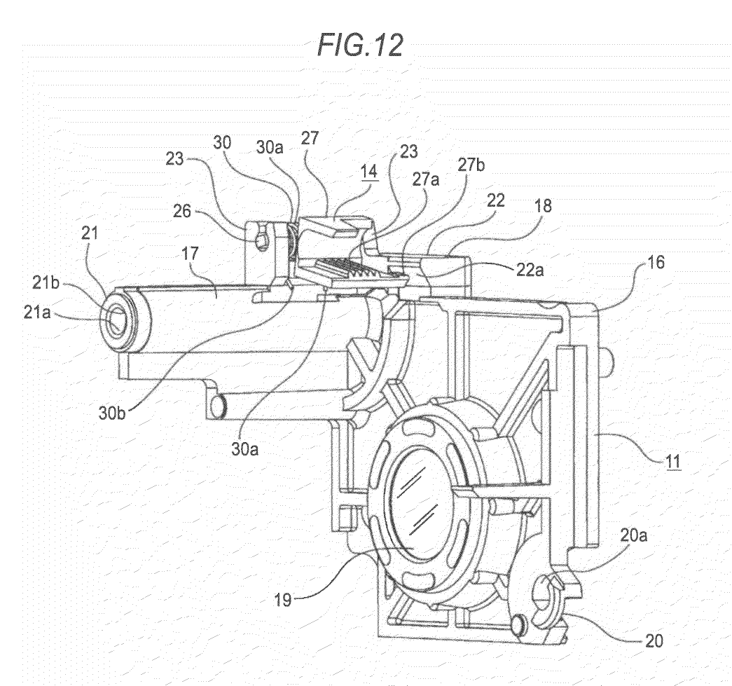

The nut member 14 can pivot relative to the nut support 18 between an engaging position (see FIGS. 10 and 11) where the rack 27a faces substantially the left and engages with the lead screw 15 and a holding position (see FIG. 12) where the held portion 27b engages with a holding portion 18a of the nut support 18 and the rack 27a is held facing substantially upward.

In the state in which the nut support 18 supports the nut member 14, the rear shaft 26 of the nut member 14 supports an urging spring 30. The urging spring 30 is, for example, a compression coil spring and formed of a coil portion 30a, a first engaging portion 30b protruding rightward from the front end of the coil portion 30a, and a second engaging portion 30c protruding rightward from the rear end of the coil portion 30a.

The coil portion 30a of the urging spring 30 is so supported by the shaft 26 that the shaft 26 fits into the coil portion 30a. The first engaging portion 30b of the urging spring 30 comes into contact with and presses upward the lower surface of the engaging portion 27 of the nut member 14, and the second engaging portion 30c of the urging spring 30 comes into contact with and presses leftward the right side surface of the base 22 of the nut support 18. As a result, the coil portion 30a of the urging spring 30 urges the nut member 14 forward relative to the nut support 18. The first engaging portion 30b of the urging spring 30 urges the nut member 14 in the direction in which the nut member 14 pivots from the holding position to the engaging position. The second engaging portion 30c of the urging spring 30 urges the lens holding frame 11 in the direction in which the lens holding frame 11 moves substantially to the left.

[Advantageous and Others Effects Provided by Urging Spring and Wedged Portion]

When the coil portion 30a of the urging spring 30 urges the nut member 14 forward relative to the nut support 18, the front surface of the base portion 24 presses forward the front shaft-receiving portion 23.

As a result, there will be no play between the nut member 14 and the lens holding frame 11, and the lenses 19, 19, . . . held in the lens holding frame 11 are stably positioned in the optical axis direction, whereby the position of the lenses 19, 19, . . . can be detected with improved precision and zooming and focusing can be performed with improved reliability.

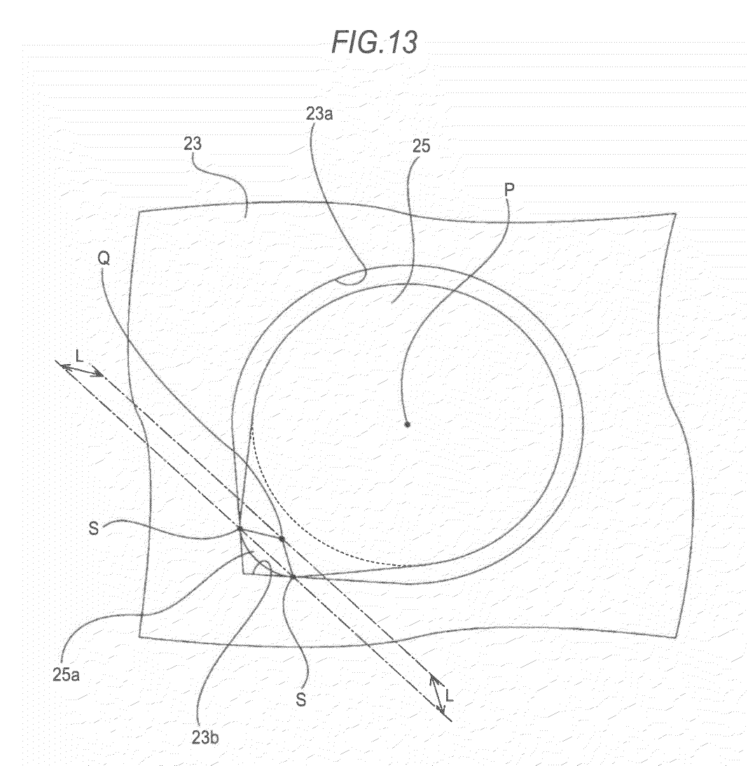

When the first engaging portion 30b of the urging spring 30 urges the nut member 14 in the direction in which the nut member 14 pivots from the holding position to the engaging position, the shaft-side wedged portion 25a provided along the shaft 25 of the nut member 14 is pressed against the receiving-side wedged portion 23b formed in the corresponding shaft-receiving portion 23 of the nut support 18. As a result, the shaft 25 receives a rotary torque not around the center P of the circular portion (the portion formed by the dotted line and the extension of the dotted line) but around a point Q within the shaft-side wedged portion 25a, as shown in FIG. 13. That is, the shaft 25 receives a rotary torque (rotation moment) according to distances L, L from the point Q to contact points S, S where the shaft-side wedged portion 25a and the receiving-side wedged portion 23b come into contact with each other.

When the distances L are small, any waviness of the lead screw 15 and hence a decentered rotation axis thereof produced when the lead screw 15 rotates will not be transferred, for example, in the form of large oscillation from the nut member 14 to the lenses 19, 19, . . . via the lens holding frame 11. Image jitter, image hopping, and other harmful phenomena will therefore not occur.

Further, since oscillation and other harmful phenomena resulting from the waviness produced when the lead screw 15 rotates do not tend to reach the lenses 19, 19, . . . , not only can the lens drive mechanism 10 be driven in a satisfactory manner, but also the attitude will vary little and the amount of noise can be reduced.

Moreover, since oscillation and other harmful phenomena resulting from the waviness produced when the lead screw 15 rotates do not tend to reach the lenses 19, 19, . . . , the distance from the lead screw 15 to the lens holding frame 11 and the distance from the lead screw 15 to the nut member 14 can be shortened and hence the size of the lens drive mechanism 10 can be reduced accordingly. Further, the manufacturing cost can be reduced by relaxing compression tolerance of the urging spring 30.

In the above example, the nut member 14 has the shafts 25 and 26, and the nut support 18 has the shaft-receiving holes 23a, 23a supported when the shafts 25 and 26 are inserted therein. Conversely, shaft-receiving holes may be formed in the nut member, and the nut support may have shafts and supports the nut member.

When the second engaging portion 30c of the urging spring 30 urges the lens holding frame 11 in such a way that the lens holding frame 11 moves substantially to the left, the guided-side wedged portions 21b formed in the guided portions 21 of the lens holding frame 11 are pressed against the guide shaft 13. It is noted that each of the guided portions 21 is so formed that the area where the guided-side wedged portion 21b comes into contact with the guide shaft 13 is minimized in the pressing direction.

The sliding resistance between the lens holding frame 11 and the guide shaft 13 is therefore small, whereby the lens holding frame 11 can move smoothly along the guide shaft 13 in the optical axis direction, and image jitter, image hopping, and other harmful phenomena will not occur.

Further, not only can the lens drive mechanism 10 be reliably driven in a satisfactory manner, but also the attitude will vary little and the amount of noise can be reduced.

Moreover, since the sliding resistance between the lens holding frame 11 and the guide shafts 12 and 13 is small, the precision of each of the components can be relaxed, and the manufacturing cost can be reduced accordingly.

In the above description, the guided-side wedged portion 21b is formed in each of the guided portions 21 of the lens holding frame 11 by way of example. Alternatively, the diameters of the guide shafts 12 and 13 may be as smaller as possible than the diameters of the supported holes 20a and 21a in the guided portions 20 and 21.

When the diameters the guide shafts 12 and 13 are as smaller as possible than the diameters the supported holes 20a and 21a, the sliding resistance between the lens holding frame 11 and the guide shafts 12 and 13 becomes smaller, whereby image jitter, image hopping, and other harmful phenomena will not occur.

Further, not only can the lens drive mechanism 10 be reliably driven in a satisfactory manner, but also the attitude will vary little and the amount of noise can be reduced. At the same time, the precision of each of the relevant components can be relaxed, and the manufacturing cost can be reduced accordingly.

Since the imaging apparatus 1 uses a compression coil spring as the urging spring 30 as described above, a simple mechanism using the urging spring 30 allows the relevant components to be urged in desired directions, whereby the number of parts and the manufacturing cost can be reduced.

Further, the urging spring 30 is formed of the coil portion 30a, the first engaging portion 30b, which protrudes from one end of the coil portion 30a, and the second engaging portion 30c, which protrudes from the other end of the coil portion 30a, and the nut member 14 and the lens holding frame 11 are urged in opposite directions around the axis of the coil portion 30a.

As a result, the nut member 14 and the lens holding frame 11 can be reliably and readily urged in desired directions, and these components can be reliably and appropriately operated while the number of parts and the manufacturing cost are reduced.

[Assembling Lens Holding Frame and Other Components in Lens Barrel Housing]

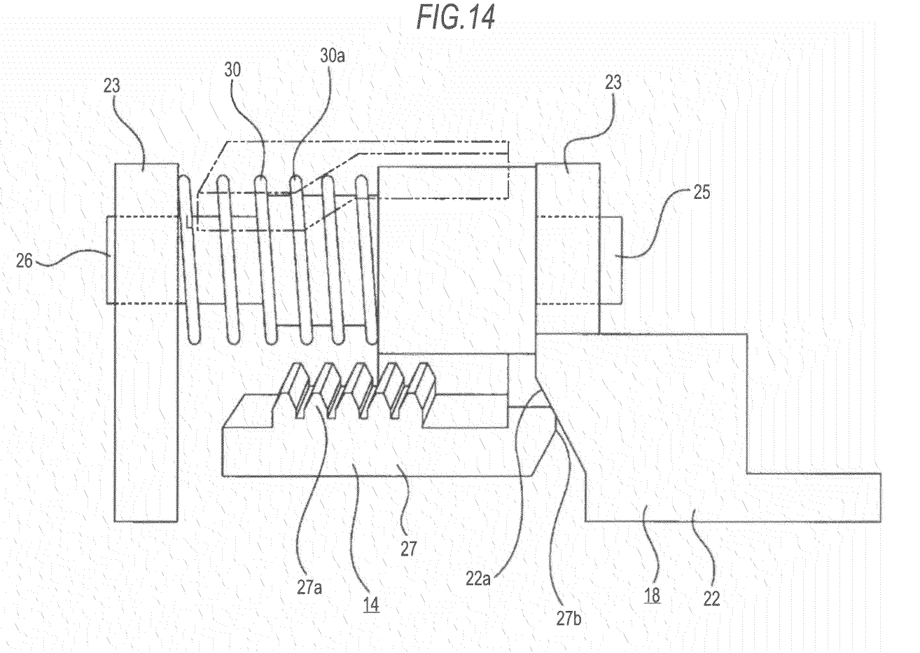

A description will be made of a procedure of assembling the lens holding frame 11 and other components in the lens barrel housing 4 (see FIGS. 14 to 20).

The guide shafts 12 and 13 are first inserted through the insertion opening 4a of the lens barrel housing 4, and then the rear end portions of the guide shafts 12 and 13 are inserted into the receiving recesses of the shaft-receiving protrusions 4e, 4e. The rear end portions of the guide shafts 12 and 13 are, for example, pressed and fit into the receiving recesses of the shaft-receiving protrusions 4e, 4e and held there.

The nut member 14 is then forced to pivot relative to the nut support 18 toward the holding position against the urging force produced by the urging spring 30. When the nut member 14 is forced to pivot toward the holding position, the held portion 27b slides along the holding portion 22a of the nut support 18. At this point, the held portion 27b is pressed against the holding portion 22a by the urging force in the front-rear direction of the urging spring 30 and the urging force around the axis of the urging spring 30, and the nut member 14 is inclined sideways in the holding position and held there (see FIG. 14).

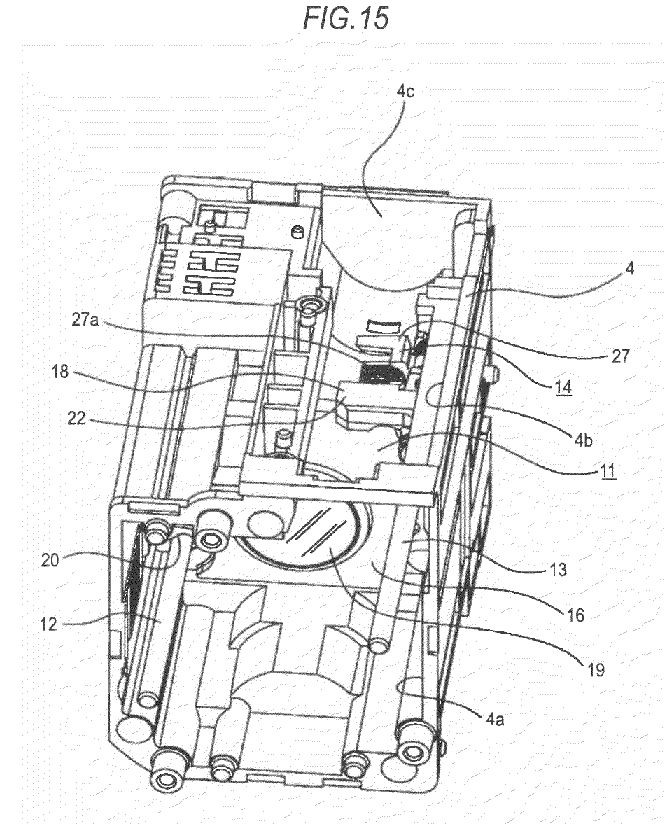

The guide shafts 12 and 13 are then inserted through the supported holes 20a and 21a of the lens holding frame 11 respectively, and the lens holding frame 11 and the nut member 14 are moved through the insertion opening 4a rearward along the guide shafts 12 and 13 and accommodated in the lens barrel housing 4 (see FIG. 15).

At this point, since the nut member 14 is held in the holding position and inclined sideways as described above, the nut member 14 is moved rearward and accommodated in the lens barrel housing 4 without coming into contact with the upper end portion of the lens barrel housing 4.

As described above, in the imaging apparatus 1, since the nut support 18 in the lens holding frame 11 has the holding portion 22a for holding the nut member 14 in the holding position, it is not necessary to enlarge the lens barrel housing 4 so that the nut member 14 does not come into contact with the lens barrel housing 4. As a result, the lens holding frame 11 and the nut member 14 can be assembled in the lens barrel housing 4 with improved workability without any enlargement of the lens barrel housing 4, whereby the yield can be improved and the manufacturing cost can be reduced.

Further, since the urging spring 30 urges and presses the held portion 27b of the nut member 14 against the holding portion 22a to hold the nut member 14 in the holding position, it is not necessary to provide a dedicated spring member for holding the nut member 14 in the holding position, whereby the number of parts and hence the manufacturing cost can be reduced.

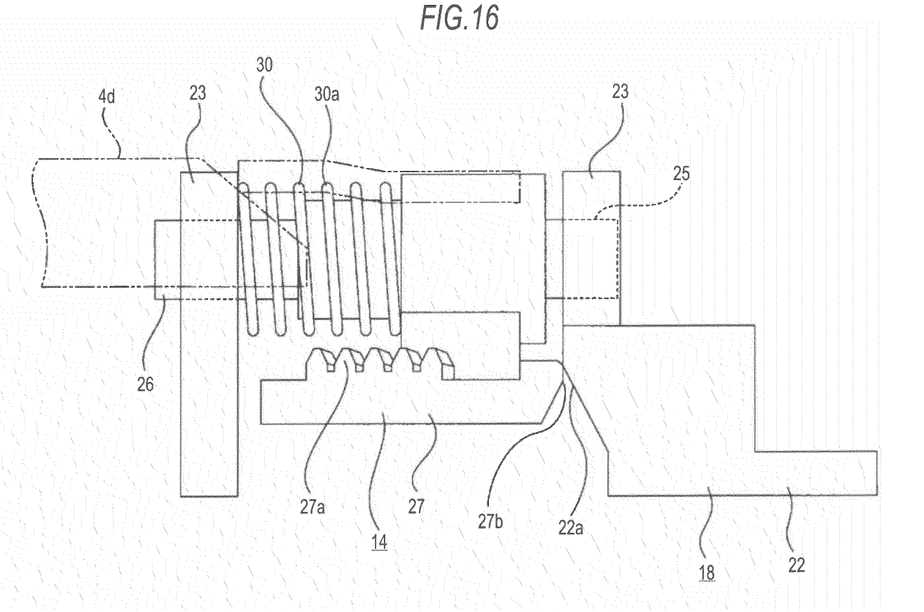

As the lens holding frame 11 and the nut member 14 are moved rearward as described above, a rear end portion of the nut member 14 held in the holding position comes into contact with and slide along the inclined surface of the releaser 4d in the lens barrel housing 4. When the rear end portion of the nut member 14 comes into contact with and slide along the releaser 4d, the releaser 4d exerts a pivotal force on the nut member 14 so that the nut member 14 pivots from the holding position toward the engaging position, and the nut member 14 starts pivoting relative to the nut support 18 toward the engaging position while being moved rearward against the urging force in the front-rear direction produced by the urging spring 30 (see FIG. 16).

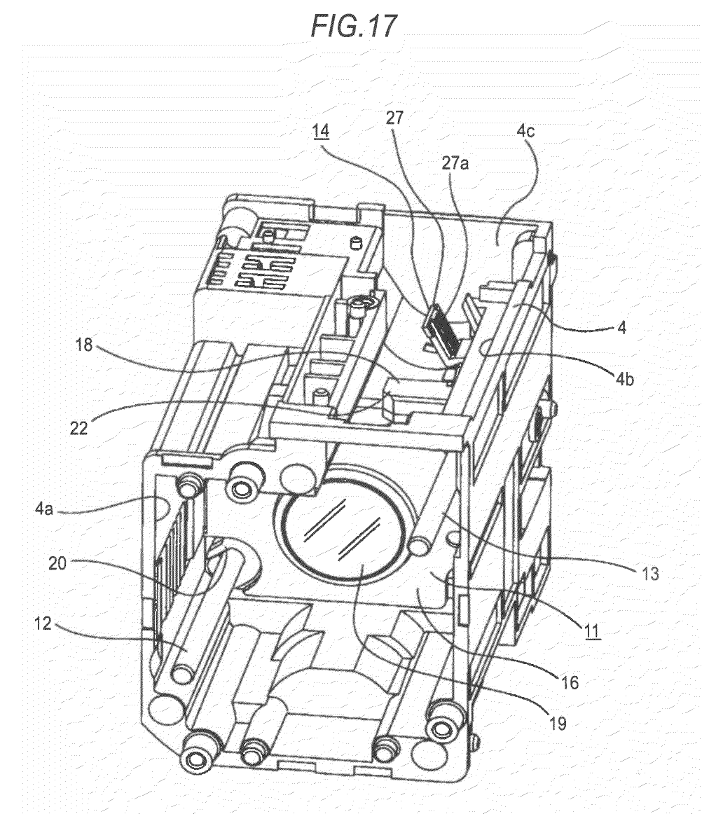

When the nut member 14 pivots from the holding position toward the engaging position, the held portion 27b disengages from the holding portion 22a, and the nut member 14 is urged by the urging force produced by the urging spring 30 around the axis thereof and pivots to the engaging position (see FIG. 17). The nut member 14 having pivoted to the engaging position is positioned in the insertion hole 4b formed in the lens barrel housing 4.

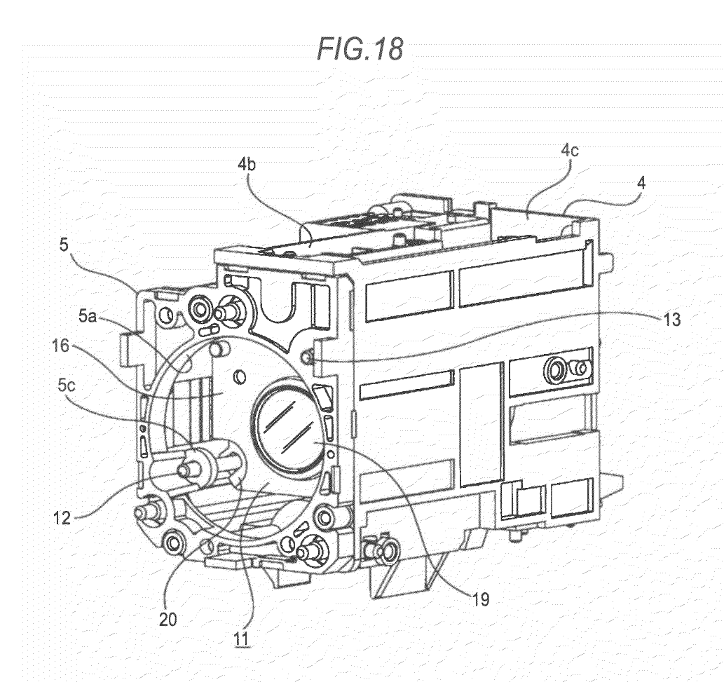

The lid member 5 is then attached to the front surface of the lens barrel housing 4 (see FIG. 18). In this process, the front end portions of the guide shafts 12 and 13 are inserted through the shaft inserting holes 5d, 5b formed through the lid member 5 so that the guide shafts 12 and 13 are held by the lid member 5.

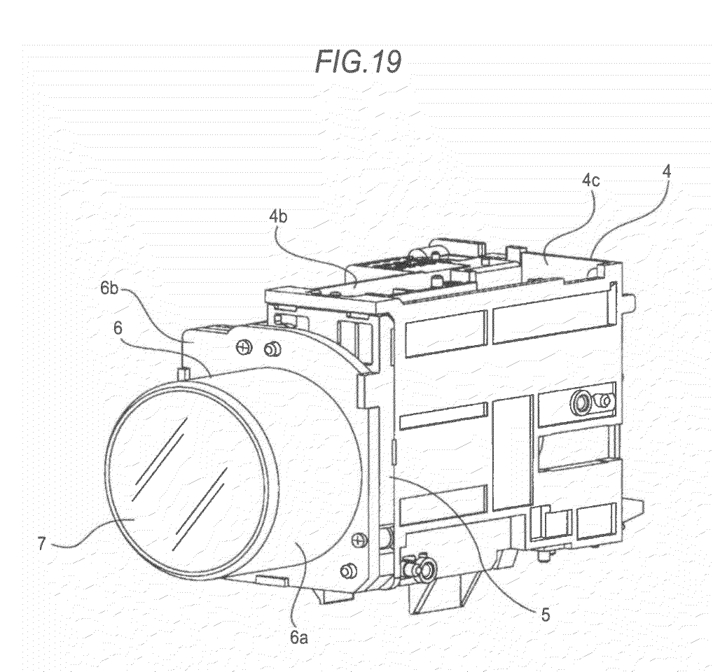

The lens holding member 6 is then attached to the front surface of the lid member 5 (see FIG. 19). At this point, the guide shafts 12 and 13 can also be pressed rearward by the rear surface of the flange 6b of the lens holding member 6.

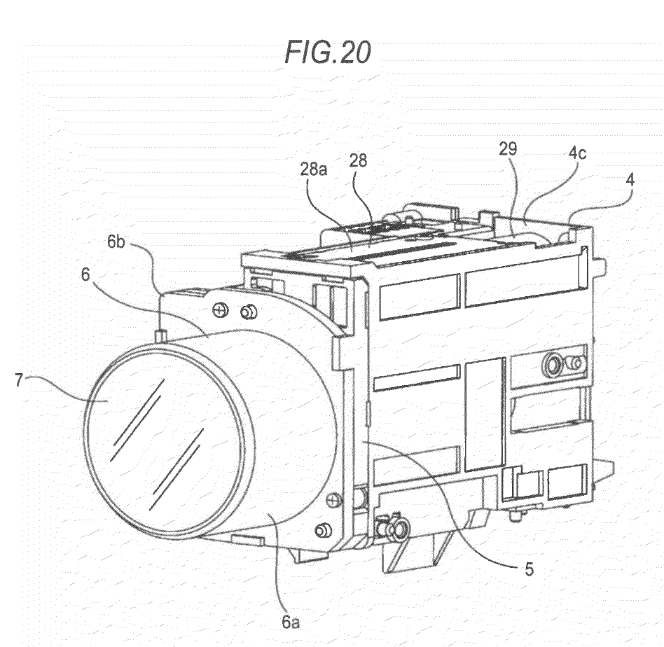

The lead screw 15 is then inserted into the engaging portion 27 of the nut member 14 held in the engaging position so that the lead screw 15 engages with the rack 27a of the engaging portion 27 (see FIG. 20). In this process, the lead screw 15 and the support sheet metal 28 that supports the lead screw 15 are inserted downward into the insertion hole 4b of the lens barrel housing 4, and the motor 29 is placed in the placement recess 4c of the lens barrel housing 4. The support sheet metal 28 is attached to the lens barrel housing 4 with screws or any other fasteners.

As described above, in the imaging apparatus 1, since the releaser 4d for releasing the nut member 14 held in the holding position is provided in the lens barrel housing 4, the nut member 14 pivots toward the engaging position when the lens holding frame 11 and the nut member 14 are accommodated in the lens barrel housing 4, whereby the lead screw 15 and the nut member 14 can be quickly and smoothly assembled.

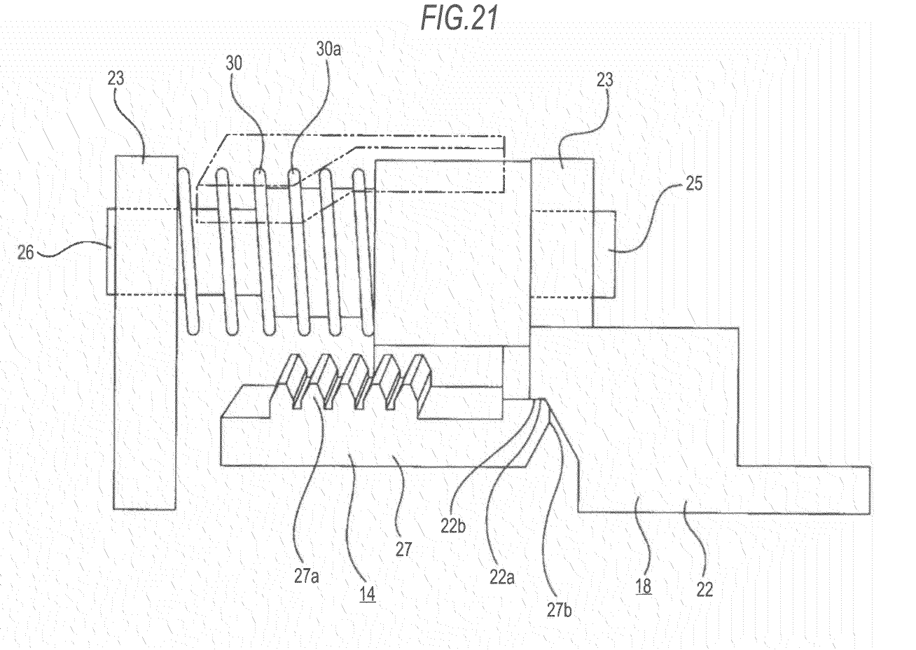

In the above description, the nut member 14 is held in the holding position by the urging forces produced by the urging spring 30 in the front-rear direction and around the axis of the urging spring 30 by way of example. Alternatively, a stepped surface 22b facing sideways maybe formed on the holding portion 22a, and the held portion 27b may engage with the stepped surface 22b so that the nut member 14 is held in the holding position only by the urging force produced by the urging spring 30 around the axis thereof, as shown in FIG. 21.

[Others]

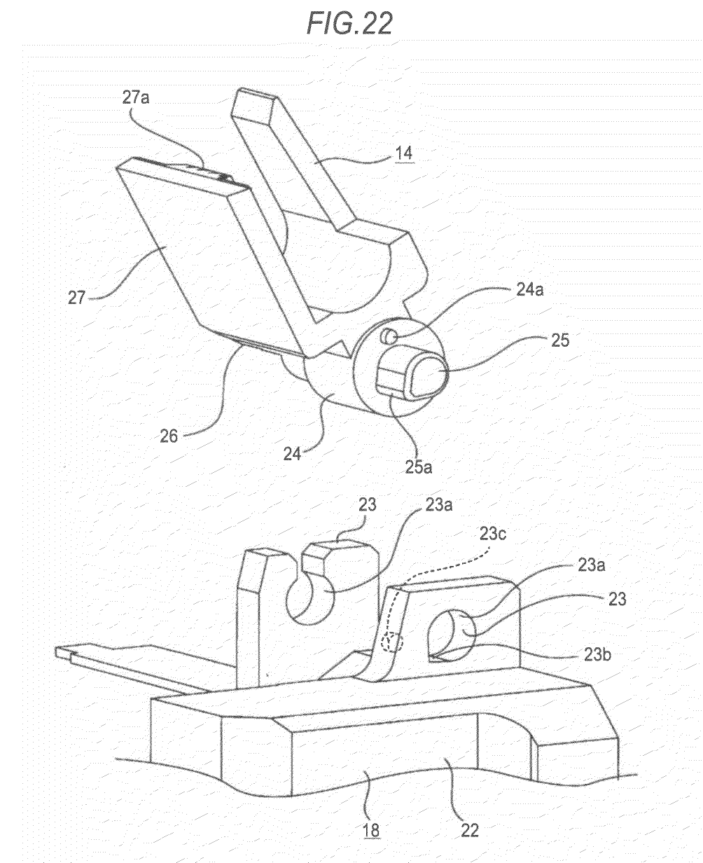

In the above description, the engaging portion 27 of the nut member 14 has the held portion 27b by way of example, but the engaging portion 27 does not necessarily have the held portion. For example, a held portion 24a may be provided on the front or rear surface of the base portion 24 (see FIG. 22). When the held portion 24a is provided on the front or rear surface of the base portion 24, a holding portion 23c may be formed in the rear surface of the front shaft-receiving portion 23 or the front surface of the rear shaft-receiving portion 23 of the nut support 18 in the lens holding frame 11.

When the held portion 24a is provided on the base portion and the holding portion 23c is formed in one of the shaft-receiving portions 23 as described above, the nut member 14 is held in the holding position when the nut member 14 pivots relative to the nut support 18 and the held portion 24a engages with the holding portion 23c by the urging force produced by the urging spring 30 in the front-rear direction.

Further, since the releaser 4d in the lens barrel housing 4 exerts a pivotal force on the nut member 14 so that the nut member 14 moves from the holding position toward the engaging position, the held portion 24a disengages from the holding portion 23c and the nut member 14 pivots relative to the nut support 18 toward the engaging position by the urging force produced by the urging spring 30.

When the lead screw 15 and the support sheet metal 28 that supports the lead screw 15 described above are inserted downward into the insertion hole 4b of the lens barrel housing 4, the nut member 14 held in the holding position can be released therefrom as follows.

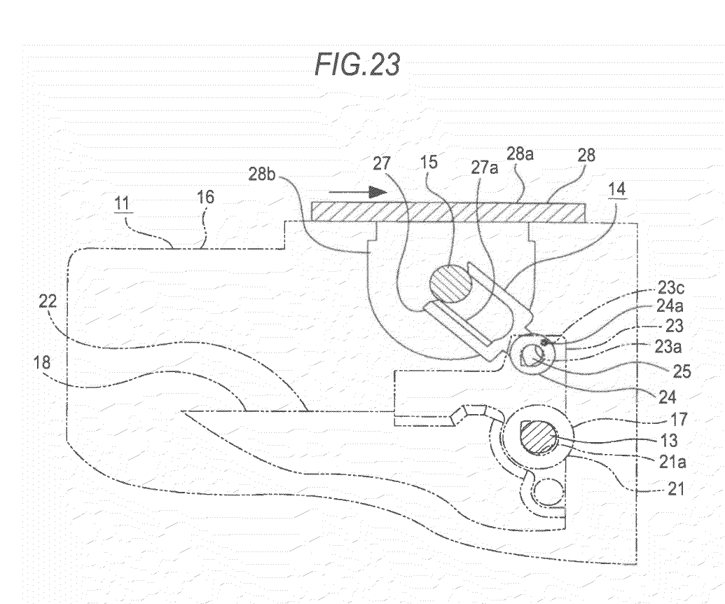

The lead screw 15 is first inserted downward into the engaging portion 27 of the nut member 14 held in the holding position (see FIG. 23). At this point, since the engaging portion 27 is inclined sideways, the lead screw 15 is inserted downward into the insertion hole 4b through a position apart sideways from a normal attachment position in the lens barrel housing 4 and engages with an upper end portion of the rack 27a.

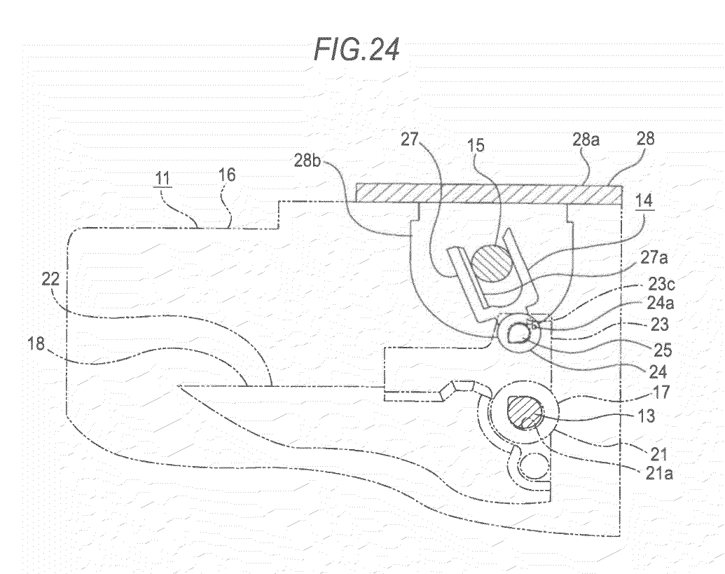

The lead screw 15 and the support sheet metal 28 are then moved sideways (see FIG. 24). When the lead screw 15 and the support sheet metal 28 are moved sideways, the nut member 14 pivots relative to the nut support 18 so that the held portion 24a disengages from the holding portion 23c and the lead screw 15 is inserted into the engaging portion 27.

After the lead screw 15 and the support sheet metal 28 are moved sideways to the normal attachment position in the lens barrel housing 4, the support sheet metal 28 is fixed to the lens barrel housing 4 with screws or any other suitable fasteners.

Moving the lead screw 15 and the support sheet metal 28 sideways to cause the nut member 14 to pivot relative to the nut support 18 so that the nut member 14 held in the holding position is released allows the nut member 14 held in the holding position to be released when the lead screw 15 is assembled in the lens barrel housing 4.

It is therefore unnecessary to provide a dedicated part for releasing the nut member 14 held in the holding position, and the nut member 14 held in the holding position can be readily and reliably released when the lead screw 15 is assembled in the lens barrel housing 4.

Further, since the nut member 14 held in the holding position is released when the lead screw 15 is assembled in the lens barrel housing 4, these components can be quickly assembled in the lens barrel housing 4, whereby the workability in the assembling process can be improved.

The method described above for releasing the nut member 14 held in the holding position when the lead screw 15 is assembled in the lens barrel housing 4 can also be used to disengage the held portion 27b provided at the engaging portion 27 described above from the holding portion 22a provided at the nut support 18.

[Embodiment of Imaging Apparatus]

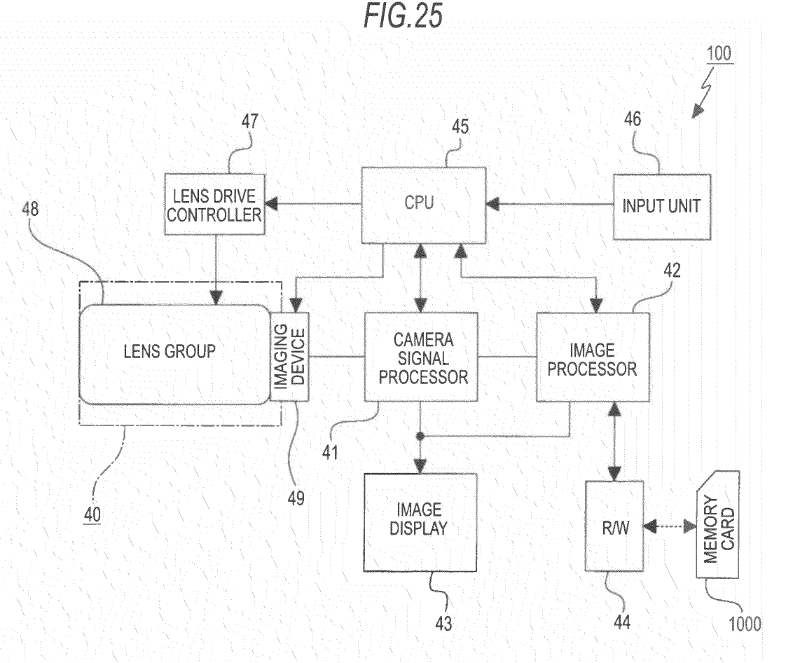

FIG. 25 is a block diagram of a video camcorder as the imaging apparatus according to an embodiment of the present disclosure.

An imaging apparatus (video camcorder) 100 includes a camera block 40 responsible for image capturing, a camera signal processor 41 that performs signal processing, such as converting an analog captured image signal into a digital image signal, and an image processor 42 that records and reproduces the resultant image signal. The imaging apparatus 100 further includes an image display 43, such as a liquid crystal panel, for displaying a captured image and other information, a R/W (reader/writer) 44 that writes and reads an image signal to and from a memory card 1000, a CPU (central processing unit) 45 that controls the entire imaging apparatus, an input unit 46 formed of a variety of switches and other components operated by a user as necessary, and a lens drive controller 47 that controls and drives lenses disposed in the camera block 40.

The camera block 40 is formed of an optical system including a lens group 48, an imaging device 49, such as a CCD (charge coupled device) and a CMOS (complementary metal-oxide semiconductor) device, and other components.

The camera signal processor 41 converts an output signal from the imaging device 49 into a digital signal, performs noise removal and image quality correction, converts the digital signal into brightness/color difference signals, and performs other signal processing.

The image processor 42 performs compression encoding and decompression decoding on an image signal based on a predetermined image data format, performs data format conversion, such as resolution conversion, and performs other image processing.

The image display 43 has a function of displaying a variety of data, such as user's operation through the input unit 46 and captured images.

The R/W 44 writes image data encoded by the image processor 42 to the memory card 1000 and reads image data recorded on the memory card 1000.

The CPU 45 functions as a control processor that controls circuit blocks provided in the imaging apparatus 100 and controls each of the circuit blocks based, for example, on an instruction input signal from the input unit 46.

The input unit 46 is formed, for example, of a shutter release button for shutter operation and a selection switch for selecting an action mode and outputs an instruction input signal according to user's operation to the CPU 45.

The lens drive controller 47 controls a motor or any other actuator (not shown) that drives lenses in the lens group 48 based on a control signal from the CPU 45.

The memory card 1000 is, for example, a semiconductor memory that can be attached and detached to and from a slot connected to the R/W 44.

The operation of the imaging apparatus 100 will be described below.

In an image capturing standby state, an image signal captured by the camera block 40 is outputted to the image display 43 through the camera signal processor 41 and displayed as camera-through images on the image display 43 under the control of the CPU 45. When a zooming instruction input signal is inputted from the input unit 46, the CPU 45 outputs a control signal to the lens drive controller 47, and a predetermined lens in the lens group 48 is moved under the control of the lens drive controller 47.

When a shutter (not shown) in the camera block 40 is operated in response to an instruction input signal from the input unit 46, the camera signal processor 41 outputs a captured image signal to the image processor 42, which performs compression encoding on the image signal and converts the encoded image signal into digital data expressed in a predetermined data format. The converted data is outputted to the R/W 44, which writes the data to the memory card 1000.

Focusing is carried out as follows: The lens drive controller 47 moves a predetermined lens in the lens group 48 based on a control signal from the CPU 45.

To reproduce image data recorded on the memory card 1000, predetermined image data is read from the memory card 1000 through the R/W 44 in response to user's operation performed through the input unit 46. The image processor 42 performs decompression decoding on the read image data, and an image signal to be reproduced is then outputted to the image display 43 and displayed as reproduced images.

The specific shapes and structures of the components shown in the mode described above are presented only by way of example for implementing the present disclosure and should not be used to construe the technical extent of the present disclosure in a limited sense.

The present disclosure contains subject matter related to that disclosed in Japanese Priority Patent Application JP 2011-005268 filed in the Japan Patent Office on Jan. 13, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A lens drive mechanism comprising:
a lens holding frame that holds a lens and has a guided portion and a nut support;
a nut member so supported by the nut support that the nut member pivotally moves around an optical axis of the lens;
a lead screw that engages with the nut member and rotates around an axis of the lead screw to move the lens holding frame; and
a guide unit that is inserted into the guided portion of the lens holding frame and guides the lens holding frame in the optical axis direction when the lead screw rotates and moves the lens holding frame,
wherein the guide unit, the lead screw, and the lens holding frame are accommodated in and attached to a lens barrel housing having an insertion opening,
the lens holding frame, which supports the nut member, is inserted through the insertion opening and accommodated in the lens barrel housing,
the nut member pivotally moves between an engaging position where the nut member engages with the lead screw and a holding position where the nut member is held when the lens holding frame is inserted into the lens barrel housing, and
a holding portion that holds the nut member in the holding position is provided at the nut support of the lens holding frame.

2. The lens drive mechanism according to claim 1,
further comprising an urging spring that urges the lens holding frame in a direction in which the guided portion is pressed against the guide unit in a direction perpendicular to the optical axis and urges the nut member in a direction in which the nut member is pressed against the lead screw in the direction perpendicular to the optical axis,
wherein an urging force produced by the urging spring presses part of the nut member against the holding portion so that the nut member is held in the holding position.

3. The lens drive mechanism according to claim 1,
wherein the urging spring urges the nut member in the optical axis direction, and
an urging force produced by the urging spring presses part of the nut member against the holding portion so that the nut member is held in the holding position.

4. The lens drive mechanism according to claim 1,
further comprising an urging spring that urges the lens holding frame in a direction in which the guided portion is pressed against the guide unit in a direction perpendicular to the optical axis, urges the nut member in a direction in which the nut member is pressed against the lead screw in the direction perpendicular to the optical axis, and urges the nut member in the optical axis direction,
wherein urging forces produced by the urging spring in the direction perpendicular to the optical axis and in the optical axis direction press part of the nut member against the holding portion so that the nut member is held in the holding position.

5. The lens drive mechanism according to claim 1,
further comprising a releaser in the lens barrel housing, the releaser releasing the nut member held in the holding position.

6. The lens drive mechanism according to claim 1,
wherein the lead screw is attached to the lens barrel housing by allowing the lead screw to engage with the nut member held in the holding position and moving the lead screw in a predetermined direction, and
when the lead screw is moved in the predetermined direction, the nut member pivots relative to the nut support and disengages from the holding position.

7. The lens drive mechanism according to claim 1,
wherein a shaft is provided on one of the nut member and the nut support and a shaft-receiving portion into which the shaft is inserted is provided on the other one of the nut member and the nut support,
the nut member is so supported by the nut support that the nut member pivotally moves around the optical axis of the lens, and
a shaft-side wedged portion and a receiving-side wedged portion are so formed on the shaft and the shaft-receiving portion that the wedged portions protrude in a direction perpendicular to axes thereof, have tapered shapes, and come into contact with each other.

8. The lens drive mechanism according to claim 7,
wherein the urging spring urges the nut member in the optical axis direction.

9. The lens drive mechanism according to claim 7,
wherein the urging spring is a compression coil spring.

10. The lens drive mechanism according to claim 7,
wherein the urging spring is formed of a coil portion, a first engaging portion protruding from one axial end of the coil portion, and a second engaging portion protruding from the other axial end of the coil portion,
the first engaging portion engages with the nut member,
the second engaging portion engages with the lens holding frame, and
the nut member and the lens holding frame are urged in opposite directions around an axis of the coil portion.

11. The lens drive mechanism according to claim 1,
wherein a guided-side wedged portion is formed in the guided portion, the guided-side wedged portion protruding in a direction perpendicular to an axis of the guided portion and having a tapered shape.

12. The lens drive mechanism according to claim 1,
wherein a fluorine coat is formed on the surface of the guide unit.

13. The lens drive mechanism according to claim 1,
wherein a fluorine coat is formed on a portion of the guided portion of the lens holding frame that comes into contact with the guide unit.

14. A lens barrel comprising:
a lens barrel housing that accommodates at least one lens and has an insertion opening;
a lens holding frame that holds the lens and has a guided portion and a nut support;
a nut member so supported by the nut support that the nut member pivotally moves around an optical axis of the lens;
a lead screw that engages with the nut member and rotates around an axis of the lead screw to move the lens holding frame; and
a guide unit that is inserted into the guided portion of the lens holding frame and guides the lens holding frame in the optical axis direction when the lead screw rotates and moves the lens holding frame,
wherein the guide unit, the lead screw, and the lens holding frame are accommodated in and attached to the lens barrel housing,
the lens holding frame, which supports the nut member, is inserted through the insertion opening and accommodated in the lens barrel housing,
the nut member pivotally moves between an engaging position where the nut member engages with the lead screw and a holding position where the nut member is held when the lens holding frame is inserted into the lens barrel housing, and
a holding portion that holds the nut member in the holding position is provided at the nut support of the lens holding frame.

15. An imaging apparatus comprising:
a lens barrel that accommodates an optical system; and
an imaging device that converts an optical image acquired through the optical system into an electric signal,
the lens barrel including
a lens barrel housing that accommodates at least one lens and has an insertion opening,
a lens holding frame that holds the lens and has a guided portion and a nut support,
a nut member so supported by the nut support that the nut member pivotally moves around an optical axis of the lens,
a lead screw that engages with the nut member and rotates around an axis of the lead screw to move the lens holding frame, and
a guide unit that is inserted into the guided portion of the lens holding frame and guides the lens holding frame in the optical axis direction when the lead screw rotates and moves the lens holding frame,
wherein the guide unit, the lead screw, and the lens holding frame are accommodated in and attached to the lens barrel housing,
the lens holding frame, which supports the nut member, is inserted through the insertion opening and accommodated in the lens barrel housing,
the nut member pivotally moves between an engaging position where the nut member engages with the lead screw and a holding position where the nut member is held when the lens holding frame is inserted into the lens barrel housing, and
a holding portion that holds the nut member in the holding position is provided at the nut support of the lens holding frame.
